(19) United States
(12) Patent Application Publication
(10) Pub. No.: US 2023/0359104 A1
(43) Pub. Date: Nov. 9, 2023

(54) Privacy Cover For Cameras On Phones And Computers

(71) Applicant: Jerry Walker, East Palatka, FL (US)

(72) Inventor: Jerry Walker, East Palatka, FL (US)

(21) Appl. No.: 18/136,998

(22) Filed: Apr. 20, 2023

Related U.S. Application Data
(60) Provisional application No. 63/338,239, filed on May 4, 2022.

(51) Int. Cl. G03B 11/04

(52) U.S. Cl. CPC G03B 11/041; G03B 11/045

(57) ABSTRACT

A privacy cover for camera openings wherein the covering can be adjusted to allow the camera on a phone or computer to have unencumbered viewing of the area. The privacy cover allows for the user to feel secure that a camera isn't in active use or if the camera is being accessed by an unauthorized third party, there isn't a video feed that is being transmitted.

### CROSS-REFERENCE TO RELATED APPLICATIONS

This application relates back to U.S. 63/338,239 filed on May 4, 2022. and incorporates that application in its entirety.

### BACKGROUND OF THE INVENTION

Laptops and desktop computers are susceptible to hacking in a way that a hacker can invade privacy by looking through the computer's webcam. Hackers may spy on family members and obtain sensitive information about both children and adults.

Children may be on the computer and end up talking to and seeing strangers they do not know. People may be unaware that their webcam is active and end up having sensitive or private conversations.

### SUMMARY OF THE INVENTION

The present subject matter provides users with a small, latched cover installed over a computer webcam. It also allows users to block the webcam from unauthorized users and notify the computer user when the webcam is active. The present subject matter enables users to simply secure cover into place over the webcam with the green side facing outward or flip it to the red side to block use of the webcam as needed via a one-way film.

This protects the computer owner by preventing the camera being active during sensitive or private conversations.

The present subject matter is a specialized camera cover for a webcam. The cover is rounded in shape, thin, and comprised of plastic or other suitable material. The cover uses an adhesive to attach to the front of the camera opening. The cover is designed such that one side will show red when the cover is closed, and the other side will show green when open.

The red side has a one-way film cover to prevent the webcam from viewing the computer user and his/her room. The cover helps protect a user's privacy and ensure they know when the webcam is active.

In some embodiments, the cover has a pivotably hinged middle point with a finger tab which allows the user to flip the cover either open or closed. The tab is held in its open or closed position by friction.

When the cover is open, a circular opening over the camera allows the camera to have unencumbered visual access to the room. Furthermore, the present subject matter has a red coloring to allow the user to visually recognize that the camera has full visual access to the room.

When the cover is closed, the circular opening is covered by the finger tab, and visual access to the room is denied. Additionally, the present subject matter has a green coloring when privacy cover is closed so the user can visually recognize that the camera no longer has full visual access to the room.

In some embodiments, the privacy cover for cameras uses a sliding tab to adjust from open to closed.

In this embodiment, the present subject matter is of a single color and does not provide any type of colorized indication of whether the camera has full visual access to the room. There is a raised tab which allows the user to slide the tab over the camera to restrict visual access to the room and user.

In some embodiments, the present subject matter has a length of 12.5 mm, a width of 7 mm, and a height of 1.3 mm. The circular opening which allows the camera access to the room has a 4.6 mm diameter.

### DESCRIPTION OF DRAWINGS

FIG. 1 shows a front view of the privacy cover in the open position with a tape measurer for size reference.

FIG. 2 shows a front view of the privacy cover in the open position for cameras on phones and computers.

FIG. 3 shows a top view of the privacy cover with the centrally located tab rotated to the middle point and a tape measurer for size reference.

FIG. 4 shows a front view of the privacy cover in the closed position for cameras on phones and computers and a tape measurer for size reference.

FIG. 5 shows a front view of the privacy cover in the closed position for cameras on phones and computers.

FIG. 6A shows a perspective view of one embodiment of the privacy cover on a phone wherein the cover slides over the camera as opposed to pivotally rotating to cover the camera.

FIG. 6B shows a perspective view of one embodiment of the privacy cover on a phone wherein the cover slides over the camera as opposed to pivotally rotating to cover the camera.

FIG. 6C shows a perspective view of one embodiment on a phone of the privacy cover wherein the cover slides over the camera as opposed to pivotally rotating to cover the camera.

FIG. 6D shows a perspective view of one embodiment of the privacy cover on a computer wherein the cover slides over the camera as opposed to pivotally rotating to cover the camera.

FIG. 6E shows a perspective view of one embodiment of the privacy cover on a computer wherein the cover slides over the camera as opposed to pivotally rotating to cover the camera.

FIG. 7A shows a front view of one embodiment of the present subject matter wherein the privacy cover is open to allow the camera to have full visual access to the room. The surface of the privacy is red, so the user is visually alerted to the presence of an exposed camera.

FIG. 7B shows a front view of one embodiment of the present subject matter wherein the privacy cover is closed to prevent the camera having full visual access to the room. The surface of the privacy is green so the user is visually alerted to the absence of an exposed camera.

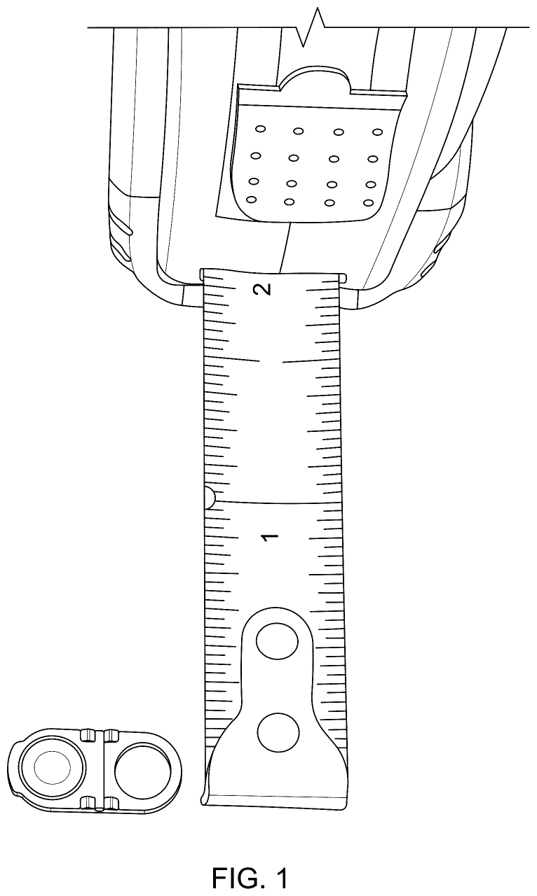

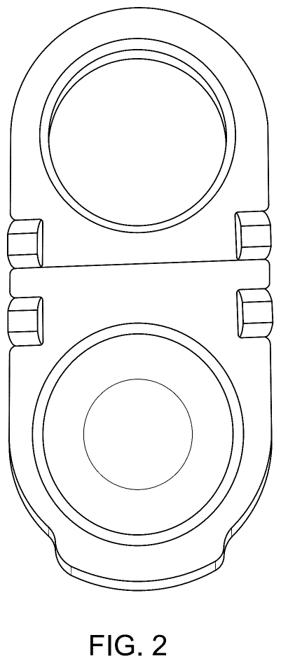

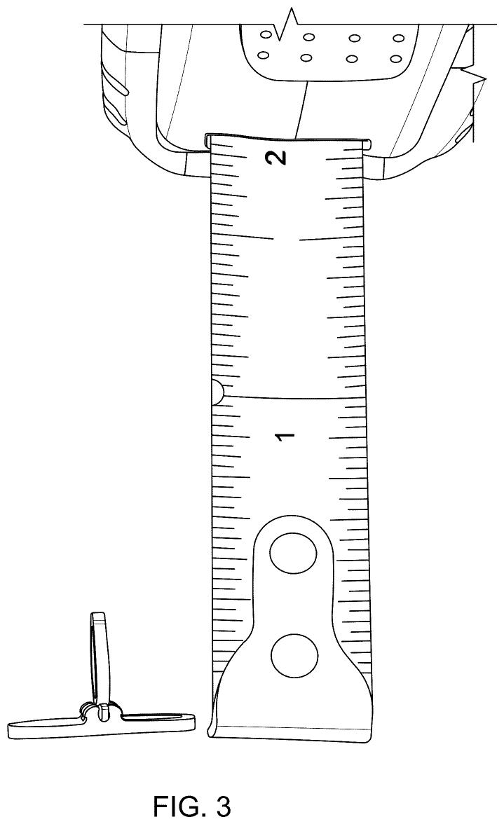

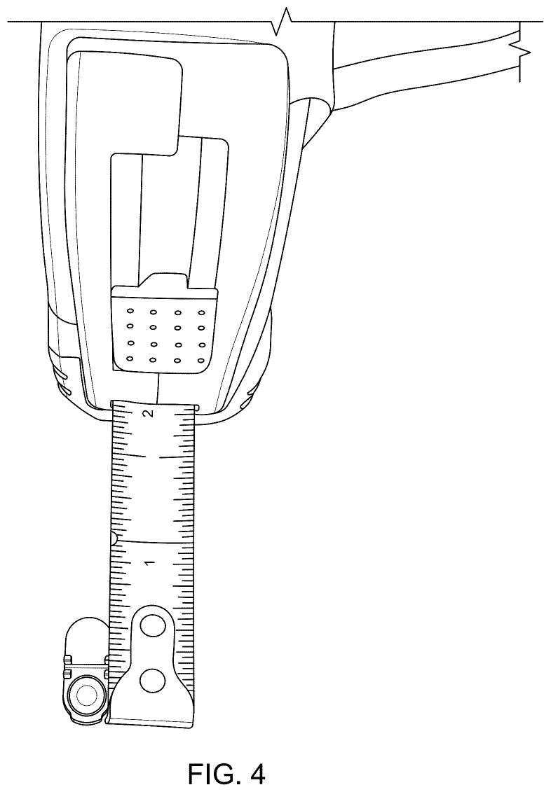

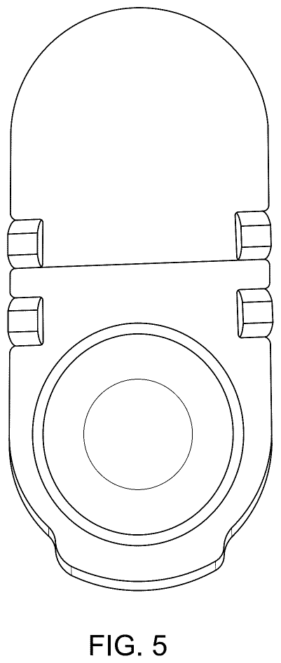

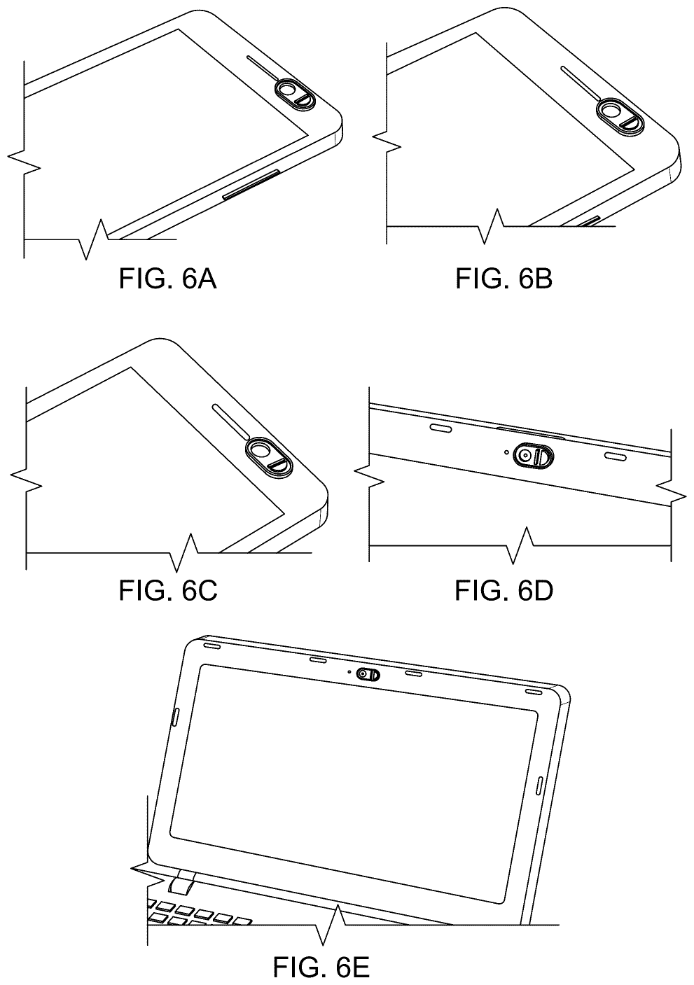

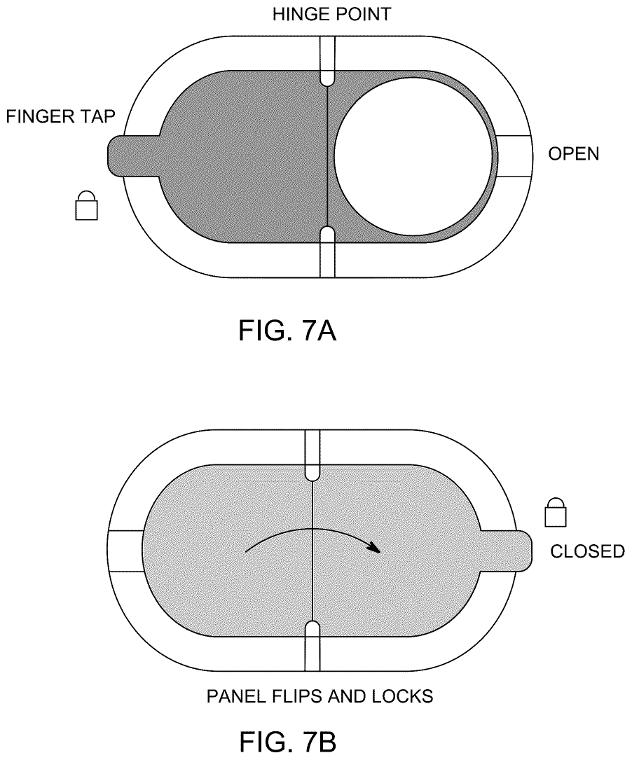

1. A privacy cover for cameras on phones and computers comprising of an adhesive backing, a sliding mechanism for covering a camera, a raised tab, and a circular opening for the camera to view through.

2. The privacy cover for cameras on phones and computers comprising of the adhesive backing, the sliding mechanism for covering the camera, the raised tab, and the circular opening for the camera to view through as in claim 1, wherein the privacy cover has a rounded shape to accommodate the sliding mechanism for covering the camera.

3. The privacy cover for cameras on phones and computers comprising of the adhesive backing, the sliding mechanism for covering the camera, the raised tab, and the circular opening for the camera to view through as in claim 2, wherein the privacy cover for cameras on phones and computers has length of 12.5 mm, width of 7 mm, height of 1.3 mm and an opening which has a diameter of 4.6 mm to facilitate the camera to view through.

4. The privacy cover for cameras on phones and computers comprising of the adhesive backing, the sliding mechanism for covering the camera, the raised tab, and the circular opening for the camera to view through as in claim 1, wherein the raised tab allows for the easy manipulation of the sliding mechanism to cover the camera.

5. A privacy cover for cameras on phones and computers comprising of an adhesive backing, a flip and lock mechanism for covering a camera, a tab, and a circular opening for the camera to view through.

6. The privacy cover for cameras on phones and computers comprising of the adhesive backing, the flip and lock mechanism for covering the camera, tab, and circular opening for the camera to view through as in claim 5, wherein the privacy cover has a rounded shape to accommodate the flip and lock mechanism for covering the camera.

7. The privacy cover for cameras on phones and computers comprising of the adhesive backing, the flip and lock mechanism for covering the camera, tab, and circular opening for the camera to view through as in claim 6, wherein the privacy cover for cameras on phones and computers has length of 12.5 mm, width of 7 mm, height of 1.3 mm and an opening which has a diameter of 4.6 mm to facilitate the camera to view through.

8. The privacy cover for cameras on phones and computers comprising of the adhesive backing, the flip and lock mechanism for covering the camera, tab, and circular opening for the camera to view through as in claim 5, wherein lip and lock mechanism is pivotally connected to the center of the privacy cover.

9. The privacy cover for cameras on phones and computers comprising of the adhesive backing, the flip and lock mechanism for covering the camera, tab, and circular opening for the camera to view through as in claim 5, wherein the tab allows for the easy manipulation of the flip and lock mechanism to cover the camera.

10. The privacy cover for cameras on phones and computers comprising of the adhesive backing, the flip and lock mechanism for covering the camera, tab, and circular opening for the camera to view through as in claim 5, wherein the privacy cover for cameras on phones and computers is red when the cover is open and the camera is exposed.

11. The privacy cover for cameras on phones and computers comprising of the adhesive backing, the flip and lock mechanism for covering the camera, tab, and circular opening for the camera to view through as in claim 5, wherein the privacy cover for cameras on phones and computers is green when the cover is closed, and the camera is covered.
